(19) United States
(12) Patent Application Publication
(10) Pub. No.: US 2006/0137574 A1
(43) Pub. Date: Jun. 29, 2006

(54) Cationic carbonate pigment for ink jet coating ink receptive layer

(76) Inventors: Janet Preston, Cornwall (GB); Anthony V Lyons, Macon, GA (US); Bomi M Bilimoria, Macon, GA (US); David Skuse, Cornwall (GB)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 10/531,946

(22) PCT Filed: Jan. 13, 2004
(86) PCT No.: PCT/US04/00012

§ 371 Date: Jan. 31, 2006

Related U.S. Application Data
(60) Provisional application No. 60/439,447, filed on Jan. 13, 2003.

(51) Int. Cl. C09C 1/02

(52) U.S. Cl. 106/464

(57) ABSTRACT

The present invention relates to new pigment compositions, coating compositions and methods for making the new compositions, such as coatings for ink jet receiving materials. The coated inkjet receiving material can provide improved printability. The pigment composition can be prepared by dispersing a carbonate pigment with at least one anionic dispersant The predispersed carbonate can then combined with at least one cationic polymer, such as a polyquaternary ammonium polymer or polyamine capable of being converted to a polyquaternary ammonium polymer.

This application claims priority to U.S. Provisional Patent Application No. 60/439,447, filed Jan. 13, 2003.

The present invention relates to new formulations for ink jet receiving materials and methods for making such formulations. The formulations comprise carbonate pigments predispersed in anionic dispersants and combined with cationic polymers.

An ink jet printer operates by ejecting uniformly shaped droplets of aqueous or solvent-based dye solutions from a nozzle onto a substrate such as paper. Each droplet adheres to a paper as a dot, where a collection of dots forms a printed image. For printing well-shaped dots, and especially for multi-color printing with ink jets, the use of paper coated with a pigment can be highly desirable. The pigment and the binder of the coating may generally serve to sorb and dry ink while maintaining the ink on the surface of the paper or receiving layer at a good resolution.

Paper coating formulations often employ binders to hold the coating pigment to reduce or eliminate its dusting or chalking. Minimizing dusting can aid the operation of the ink jet printer, since ink jet printers often have very fine orifice nozzles, which can be susceptible to clogging. The binder can also help sorb the ink. Appropriate binder concentrations are balanced between competing factors. If too much binder is present in the coating composition, much of the ink may remain on the surface instead of being sorbed, and may even smear or splatter when hitting the surface after ejection from the nozzle. Too little binder may not be sufficient to minimize pigment chalking or dusting.

Despite many developments in paper coating technology, there remains a need for new coatings, such as coatings for paper for ink jet printers.

One aspect of the present invention provides a pigment composition, comprising:

at least one calcium carbonate chosen from rhombohedral calcium carbonate and ground calcium carbonate;

at least one anionic dispersant in an amount sufficient to overdisperse the at least one calcium carbonate; and

at least one cationic polymer.

Another aspect of the present invention provides a pigment composition comprising at least one rhombohedral calcium carbonate; at least one anionic dispersant; and at least one cationic polymer.

Another aspect of the present invention provides a method of preparing a pigment, comprising combining at least one anionic dispersant with at least one calcium carbonate chosen from rhombohedral calcium carbonate and ground calcium carbonate, the at least one anionic dispersant being present in an amount effective to overdisperse the at least one calcium carbonate; and combining at least one cationic polymer with the dispersed calcium carbonate.

Another aspect of the present invention provides a paper coating composition, comprising at least one calcium carbonate chosen from rhombohedral calcium carbonate and ground calcium carbonate; at least one anionic dispersant present in an amount to overdisperse the at least one calcium carbonate; at least one cationic polymer; and at least one binder.

Another aspect of the present invention comprises a coated paper, comprising a fibrous substrate, at least one calcium carbonate chosen from rhombohedral calcium carbonate and ground calcium carbonate; at least one anionic dispersant present in an amount to overdisperse the at least one calcium carbonate; at least one cationic polymer in an amount of at least about 2 weight percent, relative to the weight of the calcium carbonate; and at least one binder.

Another aspect of the present invention provides a method of preparing a pigment, comprising (a) adding substantially simultaneously to a vessel, at least one anionically dispersed carbonate slurry and at least one cationic polymer, to form a cationic carbonate slurry; and (b) removing the cationic carbonate slurry from the vessel at a rate equal to the sum of the rate of the cationic polymer and dispersed carbonate slurry addition in (a).

### BRIEF DESCRIPTION OF THE DRAWINGS

FIG. 1 is a titration plot of dose of a polyacrylate anionic dispersant combined with a ground calcium carbonate slurry (x-axis) versus Brookfield viscosity (y-axis);

FIG. 2 is a titration plot of dose of a salt of a maleic acrylic copolymer anionic dispersant combined with a ground calcium carbonate slurry (x-axis) versus Brookfield viscosity (y-axis);

FIG. 3 is a titration plot of dose of cationic polymer (pEPI/DMA) combined with Slurry A of Example 1 (x-axis) versus Brookfield viscosity (y-axis);

FIG. 4 is a titration plot of dose of cationic polymer (pEPI/DMA) combined with Slurry B of Example 1 (x-axis) versus Brookfield viscosity (y-axis);

FIG. 5 is a photograph of a printed test pattern resulting from ink jet printing onto a coated paper comprising GCC with sodium polyacrylate dispersant as described in Example 7;

FIG. 6 is a photograph of a printed test pattern resulting from ink jet printing onto a coated paper comprising GCC with maleic acrylic dispersant as described in Example 7;

FIG. 7 is a titration plot of dose of maleic acrylic polymer dispersant combined with a precipitated calcium carbonate slurry (x-axis) versus Brookfield viscosity (y-axis); and

FIG. 8 is a titration plot of dose of cationic polymer (pEPI/DMA) combined with the dispersed PCC of Example 8 (x-axis) versus Brookfield viscosity (y-axis).

One aspect of the present invention provides a pigment composition comprising:

at least one calcium carbonate;

at least one anionic dispersant; and

at least one cationic polymer.

Exemplary pigment compositions include ink-receptive coating compositions, e.g., paper coating formulations. Many such coating compositions employ a variety of inorganic mineral pigments, such as silica. Silica, however, is very expensive. With many other pigment types, typical formulations for a receiving layer coating contain a low solids content of approximately 12% solids.

Cationic polymers have been previously used in conjunction with inorganic pigments to provide a net positive charge on a pigment, for adsorbing ink disposed from an ink jet printer. These inks are often anionic or amphoteric, i.e., containing both anionic and cationic groups. Thus, a net positive charge on the receiving substrate surface may help adhere the ink to the surface. Cationic polymers have also been known to improve water resistance of the coated substrate. According to U.S. Pat. No. 6,150,289, certain pigments with cationic polymers still resulted in coating, formulations with low solids content and poor rheology.

The present inventors have surprisingly discovered that predispersing at least one calcium carbonate pigment with at least one anionic dispersant prior to applying at least one cationic polymer results in a coating formulation that affords improved print properties. The resulting inventive coatings can offer at least one advantage chosen from, for example, higher printing ink density, water fastness, wet rub resistance, low wicking (improved resolution), and lower print bleeding. Additionally, these formulations can provide higher coating solids content. Formulations comprising the inventive pigment compositions can also achieve a solids content of as high as 65%.

Accordingly, in one aspect, the inventive method comprises combining at least one anionic dispersant with at least one carbonate, to provide a dispersed carbonate, and combining at least one cationic polymer with the dispersed carbonate.

In one aspect, the at least one carbonate is calcium carbonate. Calcium carbonate can exist in many forms, such as ground calcium carbonate or precipitated carbonate. Precipitated carbonates can be generated by a variety of known methods, such as by chemically precipitating a low solids aqueous suspension, e.g., having a solids concentration less than 25% by weight. The particles may be predominantly of a certain crystal form, which in turn affects the particle shape; e.g., scalenohedral, rhombohedral or aragonite, obtained by applying known reaction conditions, which favor the growth of crystals of the desired form. The particles may be the product of a reaction of gaseous carbon dioxide with calcium hydroxide in a slaked lime suspension in a manner well known to those skilled in the art. Ground calcium carbonate particles can be prepared by any known method, such as by conventional grinding and classifying techniques, e.g. jaw crushing followed by roller milling or hammer milling and air classifying.

In one aspect, the calcium carbonate is a rhombohedral calcium carbonate having a median particle size of about 0.5 μm or less, such as a median particle size of about 0.45 μm or less, or about 0.4 μm or less, or about 0.35 82 m or less, or about 0.3 μm or less. As used herein, the term rhombohedral applies to the general particle shape of the calcium carbonate particles in the slurry, rather than to the configuration of the crystal lattice. In one aspect, rhombohedral calcium carbonates can advantageously be used to coat paper at solids contents as high as 60%-65%. In contrast, scalenohedral calcium carbonates can generally only be used in paper coating compositions at a solids content ranging up to about 55%.

In one aspect, the calcium carbonate is ground calcium carbonate. In one aspect, the ground calcium carbonate has a median particle size of about 1.2 μm or less, such as a median particle size of about 1.1 μm or less, about 1 μm or less, about 0.75 μm or less, or about 0.5 μm or less.

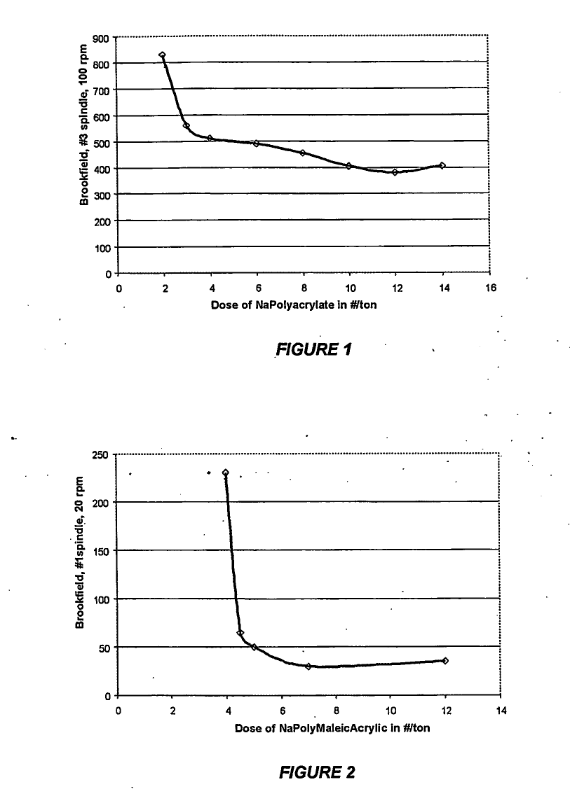

In one aspect, the at least one anionic dispersant is present in a sufficient amount such that a resulting slurry achieves a minimum viscosity, where the viscosity can be measured by using a Brookfield Viscometer. In one aspect, Brookfield viscosity is determined with the appropriate spindle set at a spindle speed of 100 rpm to give an on scale reading. In one aspect, a “sufficient” amount of anionic dispersant can be determined, for example, by titrating the anionic dispersant with the at least one carbonate. The titration can be performed with the at least one carbonate present in a slurry, such as an aqueous slurry at a given solids content. The titration results can be viewed through a plot of an amount of combined anionic dispersant (x-axis) versus the Brookfield viscosity of the carbonate slurry at a predetermined spindle rate (y-axis). Initially, when only small amounts of anionic dispersant are combined with the carbonate slurry, the viscosity decreases (see, e.g., FIG. 1 and discussion in Example 1). The viscosity reading eventually reaches a minimum as the titration proceeds. Titrating additional amounts of the anionic dispersant results in an increase in viscosity. In one aspect, “an amount” of the at least one anionic dispersant “sufficient to achieve a minimum viscosity” is the amount required to reach the titration minimum.

In another aspect, a sufficient amount of the at least one anionic dispersant in a carbonate slurry ranges from about 0.1% to about 5% by weight, relative to the dry weight of the at least one carbonate. In another aspect, a sufficient amount of the at least one anionic dispersant in a carbonate slurry ranges from about 0.5% to about 5% by weight, such as an amount ranging from about I % to about 5% by weight, relative to the dry weight of the at least one carbonate.

In one aspect, at least one cationic polymer is combined with the dispersed carbonate. Thus, upon determining the sufficient amount, the method can comprise combining the anionic dispersant with the at least one carbonate by any means known to those of ordinary skill in the art. In one aspect, the method comprises combining a sufficient amount of the at least one cationic polymer with the dispersed carbonate to achieve a minimum viscosity, as measured by a Brookfield Viscometer. In one example, a “sufficient” amount of the at least one cationic polymer can be determined by titrating the cationic polymer with the at least one carbonate, such as a carbonate present in a slurry, where the carbonate is predispersed with the at least one anionic dispersant.

The titration procedure can be performed in a manner similar to that described above, where the Brookfield viscosity of the slurry is monitored as the amount of carbonate titrated increases. Initially, the combination of small amounts of the cationic polymer with the slurry can result in an increase in the viscosity. Upon further titration, the viscosity can increase to a maximum. Further titration with the cationic polymer beyond the maximum viscosity results in a decrease in the viscosity until the viscosity eventually reaches a minimum value. The viscosity then increases again upon further addition of cationic polymer. In one aspect, “an amount” of the at least one cationic polymer “sufficient to achieve a minimum viscosity” is the amount required to reach the titration minimum.

In one aspect, a “sufficient” amount of the at least one anionic dispersant or the at least one cationic polymer falls within ±10% of the determined amount needed to achieve a minimum viscosity. In another aspect, the “sufficient” amount falls within ±5% of the determined amount needed to achieve a minimum viscosity.

In one aspect, the at least one cationic polymer is combined with the dispersed carbonate in an amount of at least about 2 weight percent, relative to the weight of the at least one carbonate. In another aspect, the at least one cationic polymer is combined with the dispersed carbonate in an amount of at least about 3 weight percent, such as amounts of at least about 4 weight percent or at least about 5 weight percent, relative to the weight of the at least one carbonate.

In certain instances, it may be useful to overdisperse the carbonate slurry with an anionic dispersant. Thus, in another aspect, upon combining a sufficient amount of the anionic dispersant needed to achieve a minimum viscosity, the method can comprise introducing an additional amount of the at least one anionic dispersant effective to overdisperse the at least one carbonate. Overdispersing with the anionic dispersant may lead to improved printing properties when the pigment is used as a paper coating. One of ordinary skill in the art can readily determine the additional amount by monitoring improved printing properties after adding the cationic polymer (see, e.g., Example 3).

The amount of additional anionic dispersant may depend on the dispersant type. In one aspect, the carbonate can be overdispersed by introducing an additional amount of the at least one anionic dispersant in an amount ranging from about 0.25 times to about 10 times the amount sufficient to achieve a minimum viscosity. In another aspect, the additional amount of anionic dispersant ranges from about 1.0 times to about 7 times the amount sufficient to achieve a minimum viscosity.

Any anionic dispersant known in the art for dispersing fine particle solids, such as inorganic particulates, can be used in accordance with the invention. Combinations of various anionic dispersants can be Used as well. The at least one anionic dispersant can comprise partially or wholly neutralized salts of polymers or copolymers, e.g., alkali metal salts and ammonium salts. In one aspect, the anionic dispersant is chosen from polycarboxylates, i.e., a polymer having at least one monomer containing a carboxylate group, such as a vinyl or olefinic group substituted with at least one carboxylic acid group or a water soluble salt. Other noncarboxylate containing monomers can be present in the polycarboxylate. Exemplary monomers for a polycarboxylate anionic dispersant include acrylic acid, methacrylic acid, itaconic acid, crotonic acid, fumaric acid, maleic acid, maleic anhydride, isocrotonic acid, aconitic acid, mesaconic acid, sinapinic acid, undecylenic acid, angelic acid, hydroxacrylic acid, and vinyl acetate. Copolymers can include monomers containing a vinyl or olefinic group, such as styrene.

Exemplary anionic dispersants include salts of polyacrylates, such as sodium polyacrylate, or salts of a maleic anhydride copolymer. Other exemplary anionic dispersants include partially or wholly neutralized salts of a water soluble copolymer of acrylic acid and maleic acid, referred to herein as a salt of a “maleic acrylic” copolymer. Such a salt may comprise, for example, an alkali metal salt, e.g. a sodium salt, or an ammonium salt of the copolymer of acrylic and maleic acids. In one aspect, the maleic acrylic copolymer can have a molar ratio of acrylic acid units to maleic acid units ranging from 0.5:1 to 10:1. In another aspect, the maleic acrylic copolymer can have a mass average molecular mass ranging from 1,000 to 100,000, such as a molecular mass ranging from 1,000 to 30,000, from 2,000 to 8,000, or from 1,000 to 10,000.

Exemplary maleic acrylic copolymers, sodium salt, are commercially available as Sokalan CP5®, Sokalan CP12°, Narlex MA-140®, Wujing® maleic acid/acrylic acid copolymer, Aquatreat AR-978°, and Nalco 8651®. Exemplary polyacrylates, sodium salt, are commercially available as Polysalt. CAL®, Polysalt FL®, Polysalt S®, Acumer 9300®, Acumer 9400®, Sokalan PA 15®, Colloid 211®, Colloid 230®, and Dispex NA40®. Exemplary polycarboxylates, sodium salt, are commercially available as Alcosperse 149-P®, Alcosperse 602-N®, and Tamol 731A®.

In one aspect, the at least one cationic polymer of the invention possesses a net positive charge. In one aspect, the cationic polymer can be a polymeric amine, such as a polymer of quaternary amines, or a polymer of amines that can be converted to quaternary amines, and combinations thereof. The cationic polymer may also contain two or more different cationic monomers, or contain a cationic monomer and other non-ionic or anionic monomers. Suitable monomers in the cationic polymer include one or more monomers selected from water soluble polyolefins containing quaternary ammonium groups which may be in the polymer chain, for example, epichlorohydrin/dimethylamine copolymers (EPI/DMA), alkyl- or dialkyldiallylammonium halides, such as dimethyidiallylammonium chloride (DMDMC), diethyldiallyl ammonium chloride (DEDAC), dimethyidiallyl ammonium bromide (DMDMB) and diethyldiallyl ammonium bromide (DEDMB), methylacryloyl-oxyethyltrimethyl ammonium chloride (METAC), acryloy-oxyethyltrimethyl ammonium chloride (AETAC), methacryloy-oxyethyltrimethyl ammonium methosulfate (METAMS), acryloyoxyethyltrimethyl ammonium methosulfate (AETAMS) or methacrylamido-propyltrimethyl ammonium chloride (MAPTAC). Other exemplary monomers include dimethylaminoethylacrylate, dimethylaminoethylmethacrylate, dimethylamino propylmethacrylamide and its methyl chloride or dimethyl sulfate quaternary ammonium salts, dimethylaminoethylacrylate and its methyl chloride salt, methacrylamidopropyltrimethylammonium chloride and its unquaternized amine form, acrylamidopropyltrimethylammonium chloride and its unquatemized amine form, and dimethylamine and epichlorohydrin. Exemplary polymers also include products of copolymerizing epichlorohydrin and amines, especially secondary amines, alone or in combination, and polymers made by polymerizing any of the above listed cationic monomers with non-ionic monomers such as acrylamide, methacrylamide or N,N-dimethylacrylamide.

Exemplary cationic polymers include polydiallyldimethylammonium chloride (pDADMAC), copolymers of quaternary dimethylaminoethyl acrylate, and copolymers of quaternary dimethylaminoethyl methacrylate, and copolymers of epichlorohydrin/dimethylamine (EPIIDMA): Exemplary suitable polymers are commercially available as Agefloc B-50LV®, Nalco 62060®, Nalco 7135, Nalco 7132®, and Nalco 8850®.

Other cationic polymers include condensates of formaldehyde with melamine, urea, or cyanoguanidine.. The cationic polymers useful in this invention also include copolymers of the aforementioned cationic monomers with nonionic monomers, such as acrylamide, methacrylamide, vinyl acetate, vinyl alcohol, N-methylolacrylamide, or diacetone acrylamide, and/or anionic monomers, such as acrylic acid, methacrylic acid, AMPS, or maleic acid, such that the net charge of these polymers is cationic.

In one aspect, the at least one cationic polymer can have a weight average molecular weight ranging from about 1,000 daltons to about 5,000,000 daltons, as determined by gel permeation chromatography. In another aspect, the at least one cationic polymer can have a molecular weight of at least about 1,000, such as molecular weights of at least about 2,000, at least about 5,000, at least about 10,000, at least about 25,000, at least about 50,000, at least about 100,000, at least about 250,000, at least about 500,000 or at least about 1,000,000. Physical blends of cationic polymers containing different cationic moieties or blends of cationic polymers possessing different molecular weight averages and distributions are also contemplated.

The bulk viscosity of the at least one cationic polymer can also reflect its weight average molecular weight. In one aspect, the at least one cationic polymer has a bulk viscosity of at least about 300 cps, such as a bulk viscosity of at least about 400 cps. In another aspect, the at least one cationic polymer has a bulk viscosity ranging from about 300 cps to about 10,000 cps. In another aspect, the at least one cationic polymer has a bulk viscosity of at least about 2, 000, such as a bulk viscosity of at least about 3,000 cps, such as a bulk viscosity of at least about 4,000 cps, or bulk viscosities ranging from about 4,000 cps to about 1,000, or from about 4,000 cps to about 6,000 cps.

In one aspect, the pigment composition includes those pigments comprising other non-carbonate particles, such as calcined kaolin, hydrous kaolin, talc, mica, dolomite, silica, zeolite, gypsum, satin white, titania, calcium sulphate, and plastic pigment.

In one aspect, the pigment composition has a solids concentration ranging from about 40% to about 65% solids, such as a solids concentration ranging from about 50% to about 65% solids or from about 55% to about 60% solids.

Another aspect of the present invention provides a pigment composition, comprising:

at least one calcium carbonate chosen from rhombohedral calcium carbonate and ground calcium carbonate;

at least one anionic dispersant in an amount sufficient to overdisperse the at least one calcium carbonate; and

at least one cationic polymer.

In one aspect, the at least one calcium carbonate is ground calcium carbonate. Exemplary pigment compositions include anionic dispersants chosen from a maleic acrylic copolymer, a maleic anhydride copolymer, and cationic polymers chosen from epichlorohydrin/dimethylamine copolymers and polyacrylate cationic polymer, which in turn can be chosen from polydiallyldimethylammonium chloride, copolymers of quaternary dimethylaminoethyl acrylate, and copolymers of quaternary dimethylaminoethyl methacrylate. Other exemplary pigment compositions include those comprising a maleic acrylic copolymer. The at least one cationic polymer can be epichlorohydrin/dimethylamine copolymer (pEPI/DMA) having a bulk viscosity of at least about 3,000, such as a bulk viscosity ranging from about 4,0006,000 cps.

Another aspect of the present invention provides a method of preparing a pigment, and the resulting compositions, wherein the pigment has a low surface area. In one aspect, the method comprises combining at least one anionic dispersant with at least one carbonate, to provide a dispersed carbonate, wherein the at least one carbonate has a surface area ranging from about 5 m²/g to about 600 m²/g, and combining at least one cationic polymer with the dispersed carbonate. In one aspect, the at least one carbonate has a surface area ranging from about 5 m²/g to about 20 m²/g.

Another aspect of the present invention comprises a method of preparing a pigment through a continuous process. Currently, cationic carbonate slurries for inkjet compositions are generally prepared by a batch process. The dispersed calcium carbonate slurry is combined with the cationic polymer, which can result in a viscous mixture. This slurry is mixed in a vessel where the motor current of the mixer is raised and the entire mixing assembly is vigorously shaken. If the mixer motor is not sized correctly for the peak current load, it can shut down.

In one aspect, the method comprises:

(a) adding substantially simultaneously to a vessel, at least one anionically dispersed carbonate slurry and at least one cationic polymer, to form a cationic carbonate slurry; and

(b) removing the cationic carbonate slurry from the vessel at a rate equal to the sum of the rate of the cationic polymer and dispersed carbonate slurry addition in (a).

In one aspect, “adding substantially simultaneously” excludes a process where one component is added such that the removing in (b) removes anionically dispersed carbonate. In one aspect, the substantially simultaneous addition can help ensure that the components are appropriately mixed prior to their removal from the vessel. A “vessel” can be any container capable of handling such slurries, such as a tank.

In one aspect, the product slurry removal rate matches the sum of the cationic polymer and dispersed carbonate slurry addition rate to maintain a constant slurry volume in the vessel. In one aspect, the adding in (a) occurs at a rate ranging from about 1% to about 25% of the vessel slurry volume per minute. In another aspect, the removing in (b) occurs at a rate ranging from about 2% to about 12% of the vessbl slurry volume per minute, such as a removal rate ranging from about 3% to about 10%.

Another aspect of the present invention relates to paper coating compositions, comprising at least one calcium carbonate, at least one anionic dispersant, at least one cationic polymer, and at least one binder. In one aspect, the at least one calcium carbonate is chosen from rhombohedral calcium carbonate, ground calcium carbonate, and precipitated calcium carbonate. In one aspect, the paper is used as a receiving layer for ink jet printing. Thus, “paper” as used herein refers to any substrate capable of receiving ink disposed from an ink jet printer and maintaining the image printed thereon, e.g., an ink jet receiver, or an ink jet receiving layer or coating.

In one aspect, the paper coating composition comprises at least one carbonate predispersed in at least one anionic dispersant, at least one cationic polymer, and at least one binder. “At least one carbonate predispersed in at least one anionic dispersant” refers to a composition where the at least one carbonate was dispersed with the at least one anionic dispersant prior to combining with the at least one cationic polymer and the at least one binder.

In one aspect, the at least one carbonate is present in the composition in an amount ranging from about 10% to about 70% by weight, relative to the total weight of the composition, such as an amount ranging from about 20% to about 70%, from about 10% to about 50%, from about 20% to about 50%, or from about 20% to about 30% by weight, relative to the total weight of the composition.

In one aspect, the coating composition has a solids content ranging from about 10% to about 70% by weight, such as an amount ranging from about 20 to about 60% by weight, relative to the total weight of the composition. In one aspect, the coating composition, when applied to paper, affords good wicking properties. Higher wicking values reflect a better performance. In one aspect, the coated paper has a wicking value of at least about 0.5, such as a wicking value of at least about 1. The wicking value is determined by printing a black line in a yellow field on the ink jet printer being used for the evaluation. An image analysis using an optical scope is done on a 10× image. The area of the black and the perimeter of the black in the image is determined. The wicking value is then 10000/(area*perimeter). The higher the wicking value the better is the resolution.

In another aspect, the coating composition can be assessed based on the red ink (magenta) or cyan print density. Print density is determined with a densitometer on solid printed areas of an ink jet printed test form. The areas tested are the primary colors of the ink jet cartridge used. In one aspect, ink printed on the coated paper has a cyan print density of at least about 0.75, such as a cyan print density of at least about 0.8, or a cyan print density of at least about 1. In another aspect, ink printed on the coated paper has a magenta print density of at least about 0.5, such as a magenta print density of at least about 0.75, a magenta print density of at least about 1, or a magenta print density of at least about 1.1.

Another aspect of the present invention provides a coated paper comprising a fibrous substrate, at least one calcium carbonate; at least one anionic dispersant; at least one cationic polymer; and at least one binder. In one aspect, the at least one cationic polymer is present in an amount of at least about 2 weight percent, relative to the weight of the calcium carbonate.

The at least one binder of the composition may comprise an adhesive derived from natural starch obtained from a known plant source as described herein, although it is not essential to use starch as a binder ingredient. Other binders, which may be used with or without starch, can also be used as is well known by those of ordinary skill in the art.

Where starch is employed as a binder ingredient, the starch may be unmodified or raw starch, or it may be modified by one or more chemical treatments known in the art. The starch may, for example, be oxidized to convert some of its —CH₂OH groups to —COOH groups. In some cases the starch may have a small proportion of acetyl (—COCH₃) groups. Alternatively, the starch may be chemically treated to render it cationic or amphoteric, i.e., with both cationic and anionic charges. The starch may also be converted to a starch ether, or hydroxyalkylated starch by replacing some —OH groups with, for example, —OCH₂CH₂OH groups, —OCH₂CH₃ groups and/or —OCH₂CH₂CH₂OH groups. A further class of chemically treated starches that may be used is that known as the starch phosphates. Alternatively, the raw starch may be hydrolyzed by means of a dilute acid or an enzyme to produce a gum of the dextrin type.

The starch binder used in the composition according to this aspect of the invention can be present in an amount ranging from about 4% to about 50% by weight, such as an amount ranging from about 4% to about 25% by weight, based on the dry weight of pigment. The starch binder may be used in conjunction with one or more other binders, for example synthetic binders of the latex or polyvinyl acetate or polyvinyl alcohol type. When the starch binder is used in conjunction with another binder, e.g., a synthetic binder, the amount of the starch binder can be present in an amount ranging from about 2% to about 98% by weight, based on the weight of dry pigment, and the amount of the synthetic binder can be present in an amount ranging from 2% to 98% by weight, based on the weight of dry pigment. In one aspect, at least 50% by weight of the binder mixture comprises modified or unmodified starch.

Other exemplary binders include, but are not limited to, adhesives derived from natural starch obtained from a known plant source, for example, wheat, maize, potato or tapioca; synthetic binders, including styrene butadiene, acrylic latex, vinyl acetate latex, or styrene acrylic; casein; polyvinyl alcohol; polyvinyl acetate; or mixtures thereof.

Appropriate amounts of binder in the coating composition are based upon the desired end product and would be readily apparent to the skilled artisan. Binder levels are controlled to allow the surfaces to receive ink without disruption. The latex binder levels for paper coatings generally range from about 3% to about 50%, such as an amount ranging from about 3% to about 30%. In one aspect according to the present invention, the binder is present in the paper coating in an amount of from about 3% to about 10%. In another aspect according to the present invention, the binder is present in the coating in an amount ranging from about 10% to about 30% by weight. In other aspects, the binder is present in the coating composition in an amount ranging from about 8% to about 20%, or from about 8% to about 15% by weight of the solids content of the composition. The amount employed will depend upon the composition and the type of binder, which may itself incorporate one or more ingredients.

The paper coating composition according to the present invention may optionally include at least one additional additive including, but not limited to, dispersants, cross linkers, water retention aids, viscosity modifiers or thickeners, lubricity or calendering aids, antifoamers/defoamers, gloss-ink hold-out additives, dry or wet rub-improvement or abrasion resistance additives, dry or wet pick improvement additives, optical brightening agents or fluorescent whitening agents, dyes, biocides, leveling or evening aids, grease or oil resistance additives, water resistance additives and/or insolubilizers.

For example, optional additives can include:

(a) cross linkers: May be present in an amount sufficient to provide sufficient cross-linking, e.g., in levels of up to 5% by weight. Suitable non-limiting examples of effective cross-linking agents include, for example, glyoxals, melamine formaldehyde resins, and ammonium zirconium carbonates.

(b) water retention aids: May be present in an amount sufficient to provide a desired water-retention effect, e.g., in an amount up to 2% by weight. Suitable non-limiting examples of a water retention aid include, for example, sodium carboxymethyl cellulose, hydroxyethyl cellulose, PVA (polyvinyl acetate), starches, proteins, polyacrylates, gums, alginates, polyacrylamide bentonite and other commercially available products sold for such applications.

(c) viscosity modifiers or thickeners: May be present in an amount sufficient to provide a desired thickening effect, e.g., in levels up to 2% by weight. Suitable non-limiting examples of effective viscosity modifiers (also commonly referred to as thickeners) include, for example, polyacrylates, emulsion copolymers, dicyanamide, triols, polyoxyethylene ether, urea, sulphated castor oil, polyvinyl pyrrolidone, montmorillonite, CMC (carboxymethyl celluloses), sodium alginate, xanthan gum, sodium silicate, acrylic acid copolymers, HMC (hydroxymethyl celluloses), HEC (hydroxyethyl celluloses).

(d) lubricity/calendering aids: May be present in an amount sufficient to provide a desired lubricity/calendering effect, e.g., in levels up to 2% by weight. Suitable non-limiting examples of effective lubricity/calendering aids include, for example calcium stearate, ammonium stearate, zinc stearate, wax emulsions, waxes, alkyl ketene dimer, and glycols.

(e) dispersants: May be present in an amount sufficient to provide a desired dispersant effect, e.g., in levels up to 2 per cent by weight. Suitable non-limiting examples of effective dispersants include, for example, polyelectrolytes such as polyacrylates and copolymers containing polyacrylate species, especially polyacrylate salts (e.g., sodium and aluminium optionally with a group II metal salt), sodium hexametaphosphates, non-ionic polyol, polyphosphoric acid, condensed sodium phosphate, non-ionic surfactants, alkanolamine and other reagents commonly used for this function.

(f) antifoamers/defoamers: May be present in an amount sufficient to provide a desired antifoamer/defoamer effect, e.g., in levels up to I% by weight. Suitable non-limiting examples of effective antifoamers/defoamers include, for example, blends of surfactants, tributyl phosphate, fatty polyoxyethylene esters plus fatty alcohols, fatty acid soaps, silicone emulsions and other silicone containing compositions, waxes and inorganic particulates in mineral oil, blends of emulsified hydrocarbons and other compounds sold commercially to carry out this function.

(g) dry or wet pick improvement additives: May be present in an amount sufficient to provide a desired dry or wet pick improvement, e.g., in levels up to 2% by weight. Suitable, non-limiting examples of dry or wet pick improvement additives include, for example, melamine resin, polyethylene emulsions, urea formaldehyde, melamine formaldehyde, polyamide, calcium stearate, styrene maleic anhydride and others.

(h) dry or wet rub improvement and abrasion resistance additives: May be present in an amount sufficient to provide a desired degree of dry or wet rub improvement and abrasion resistance, e.g., in levels up to 2% by weight., Suitable non-limiting examples of dry or wet rub improvement and abrasion resistance additives include, for example, glyoxal based resins, oxidized polyethylenes, melamine resins, urea formaldehyde, melamine formaldehyde, polyethylene wax, calcium stearate and others.

(i) gloss-ink hold-out additives: May be present in an amount sufficient to provide an effective gloss-ink hold out effect, e.g., in levels up to 2% by weight. Suitable non-limiting examples of such additives include, for example oxidized polyethylenes, polyethylene emulsions, waxes, casein, guar gum, CMC, HMC, calcium stearate, ammonium stearate, sodium alginate and others.

(j) optical brightening agents (OBA) and fluorescent whitening agents (FWA): May be present in an amount effective to provide suitable optical brightening and fluorescent whitening effects, e.g., in levels up to 1% by weight. Suitable non-limiting examples of such agents include, for example, stilbene derivatives.

(k) dyes: May be present in an amount sufficient to provide the desired amount of dyeing, e.g., in levels up to 0.5% by weight.

(l) biocidesispoilage control agents: May be present in an amount sufficient to provide the desired biocidal effect or spoilage control, e.g., in levels up to 1% by weight. Suitable non-limiting examples of such agents include, for example, metaborate, sodium dodecylbenene sulphonate, thiocyanate, organosulphur, sodium benzonate and other compounds sold commercially for this function e.g., the range of biocide polymers sold by Calgon Corporation.

(m) leveling and-evening aids: May be present in an amount sufficient to provide the desired leveling and evening effect, e.g., in levels up to 2% by weight. Suitable non-limiting examples of such agents include, for example, non-ionic polyol, polyethylene emulsions, fatty acid, esters and alcohol derivatives, alcohol/ethylene oxide, sodium CMC, HEC, alginates, calcium stearate and other compounds sold commercially for this function.

(n) grease and oil resistance additives: May be present in an amount sufficient to provide the desired amount of grease and oil resistance, e.g., in levels up to 2% by weight. Suitable non-limiting examples of such additives include, e.g., oxidized polyethylenes, latex, SMA (styrene maleic anhydride), polyamide, waxes, alginate, protein, CMC, HMC.

(o) water resistance additives: May be present in an amount sufficient to provide the desired degree of water resistance, e.g., in levels up to 2% by weight. Suitable non-limiting examples of such additives include, e.g., oxidized polyethylenes, ketone resin, anionic latex, polyurethane, SMA, glyoxal, melamine resin, urea formaldehyde, melamine formaldehyde, polyamide, glyoxals, stearates and other materials commercially available for this function.

(p) insolubilizer: May be present in an amount sufficient to provide a desired insolubility effect, e.g., in levels up to 2% by weight.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by the present invention.

It is to be understood that both the foregoing general description and the following examples are exemplary and explanatory only and are not restrictive of the invention, as claimed.

### EXAMPLE 1

Anionic dispersant. The following example illustrates one technique for optimizing the amount of anionic dispersant for dispersing a carbonate. An anionic dispersant was titrated with a slurry containing ground calcium carbonate (95%<2 μm). FIGS. 1 and 2 show titration plots of anionic dispersant dosage (x-axis) versus Brookfield viscosity (y-axis) of the slurry. The Brookfield viscosity is measured by using a Brookfield Viscometer with a # 3 spindle set at a spindle speed of 100 rpm. In FIG. 1, the anionic dispersant is sodium polyacrylate (Slurry A). In FIG. 2, the anionic dispersant is a sodium salt of a maleic acrylic copolymer (Slurry B; sodium salt of an acrylic/maleic acid copolymer having a 2:1 molar acrylic/maleic acid ratio and average molecular mass of 4000). Both slurries were prepared in accordance with the invention. It can be seen that the amount of anionic dispersant needed to achieve a minimum viscosity is lower for the maleic acrylic copolymer compared to the polyacrylate.

### EXAMPLE 2

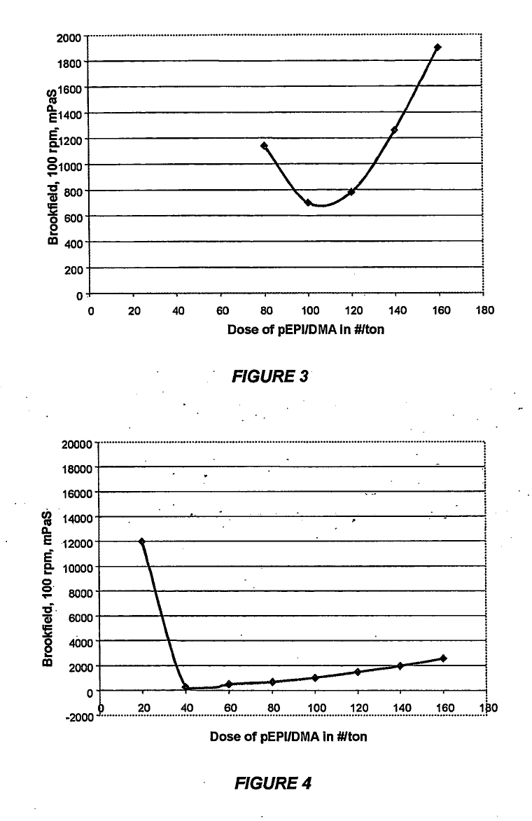

Cationic polymer. The following example illustrates a titration technique for optimizing the amount of cationic polymer to be combined with a carbonate pigment predispersed with an anionic dispersant. A cationic polymer was titrated with Slurries A and B of Example 1. The cationic polymer was an epichlorohydrin/dimethylamine copolymer (pEPI/DMA, bulk viscosity=40006000 cps). FIGS. 3 and 4 show titration plots of cationic polymer dosage (x-axis) versus Brookfield viscosity (y-axis) of the slurry. The Brookfield viscosity is measured by using a Brookfield Viscometer with a #3 spindle set at a spindle speed of 100 rpm. In FIG. 3, the cationic polymer was titrated with Slurry A of Example 1. In FIG. 4, the cationic polymer was titrated with Slurry B of Example 1. It can be seen that the amount of cationic polymer needed to achieve a minimum viscosity is lower for Slurry B than for Slurry A.

Effect of the molecular weight of the cationic polymer. In some instances, a cationic polymer of a sufficiently high molecular weight can lead to improved printing results. Often, if a lower molecular weight cationic polymer is used, more fluid polymer is needed and, the resultant prints can suffer a pronounced loss of definition with increased wicking and bleeding. This Example compares the results of a higher molecular weight cationic polymer to a lower molecular weight cationic polymer.

A calcium carbonate slurry was prepared by combining 3.45 pph (parts per hundred of dry weight of pigment) each of both cationic polymers with ground calcium carbonate (95%<2 μm) predispersed with maleic acrylic copolymer. Both cationic polymers are provided as 40 wt% solids.

Coating formulations were prepared by adding 8 pph Airvol 502 PVOH to each slurry above, followed by adding 1 pph cationic polymer, with the polymer at 40 wt % solids. NaOH solution was added to adjust the pH to 8.5 and the color was then screened. The lower molecular weight polymer produced similar color viscosity to the original polymer at 4 wt % higher solids. The cationic slurry and color properties are tabulated below.

| | | | To Brookfield Viscosity mPa · s | | | |
|---|---|---|---|---|---|---|
| | Polymer | Solids | 10 | 20 | 50 | 100 |
| Cationic Polymer | Code | (wt. %) | rpm | rpm | rpm | rpm |
| Slurry | | | | | | |
| pEPI/DMA | High MW | 46.6 | 4700 | 2825 | 1600 | 845 |
| (bulk viscosity = | | | | | | |
| 4000-6000 cps) | | | | | | |
| pEPI/DMA | Low MW | 52.6 | 7000 | 4200 | 2360 | 1700 |
| (bulk viscosity = | | | | | | |
| 400-900 cps) | | | | | | |
| Color | | | | | | |
| pEPI/DMA | High MW | 41.7 | 2550 | 1625 | 930 | 630 |
| (bulk viscosity = | | | | | | |
| 4000-6000 cps) | | | | | | |
| pEPI/DMA | Low MW | 45.8 | 1300 | 950 | 660 | 510 |
| (bulk viscosity = | | | | | | |
| 400-900 cps) | | | | | | |

The calendered coated papers were printed with an Epson Stylus Photo 870 inkjet printer with Epson Photo Quality Inkjet Paper settings. Print density measurements were made one day after printing and the results are tabulated below.

| | Epson Print Density | | | | Visual |
|---|---|---|---|---|---|
| | (photo quality setting) | | | | assessment of |
| Paper | Black | Cyan | Magenta | Yellow | print quality |
| Controls | | | | | |
| Epson Premium | 1.41 | 1.20 | 1.03 | 0.72 | good |
| Plain | | | | | |
| Epson Photo | 1.87 | 1.79 | 1.52 | 0.97 | very good |
| Coated | | | | | |
| Wood free | | | | | |
| base paper | | | | | |
| (105 gsm) | | | | | |
| uncoated | 1.46 | 1.30 | 1.16 | 0.79 | good |
| high MW | 1.48 | 1.20 | 1.21 | 0.91 | good |
| pEPI/DMA | | | | | |
| lower MW | 1.48 | 1.23 | 1.22 | 0.92 | considerable |
| pEPI/DMA | | | | | wicking and |
| | | | | | bleeding |

The results in the table above indicate that: (1) superior print densities can be achieved when using color containing high molecular weight cationic polymer, as compared to the uncoated base paper and the Epson Premium Plain paper; and (2) visual assessment of the prints has shown that the lower MW polymer has inferior print quality with inter bleeding of the ink dyes.

### EXAMPLE 3

Overdispersing with anionic dispersant. It was unexpectedly discovered that overdispersing the carbonate with anionic dispersant can lead to a formulation providing good printing properties, as tabulated below. In this Example, various coatings were prepared where the amount of anionic maleic acrylic copolymer present in the coating composition comprising ground calcium carbonate (95%<2 μm) is varied. The printing results are tabulated below. Over-dosing is determined with respect to the optimal dose for minimum rheology.

| | pEPI/ | | | | | |
|---|---|---|---|---|---|---|
| | DMA | | | | | |
| % maleic | (bulk | | | | | |
| acrylic | viscos- | | | | | |
| (maleic | ity = | | | | | Visual |
| acrylic | 2040- | | | | | assessment |
| copoly- | 2840 | Print Density | | | | of print |
| mer**) | cps) | Black | Cyan | Magenta | Yellow | quality |
| 0.5* | 4 | 1.30 | 1.32 | 0.98 | 0.75 | slight |
| | | | | | | bleeding |
| 0.5* | 6.5 | 1.37 | 1.33 | 1.08 | 0.82 | moderate to |
| | | | | | | bad bleeding |
| 1.5 | 7 | 1.35 | 1.34 | 1.06 | 0.80 | slight |
| | | | | | | bleeding |
| 2.0 | 7.5 | 1.39 | 1.33 | 1.08 | 0.83 | quite good |
| 2.5 | 8.5 | 1.41 | 1.35 | 1.09 | 0.84 | good |
| 3.0 | 9.5 | 1.43 | 1.33 | 1.14 | 0.86 | good/slight |
| | | | | | | bleeding |

*optimum dose for minimum rheology
**sodium salt of an acrylic/maleic acid copolymer having a 2:1 molar acrylic/maleic acid ratio and average molecular mass of 4000

The table above shows that over-dosing the carbonate with 2.5 wt.% of the maleic acrylic copolymer provided an optimal balance of high print density and good visual print quality. The data in the second row of this table shows that increasing the dose of cationic polymer while maintaining the same dose of the maleic acrylic copolymer does not improve printability.

### EXAMPLE 4

In this Example, various calcium carbonate pigments were treated with anionic dispersants and cationic polymers, according to the invention, and incorporated into a coating formulation. A calcined kaolin (“Clay Sample”) was also predispersed with an anionic dispersant followed by combining with a cationic polymer. The Table below lists the physical properties of the pigments evaluated prior to any chemical treatment.

| | | | | Clay |
|---|---|---|---|---|
| Property | Sample A | Sample B | Sample C | Sample |
| Pigment type | GCC | aragonitic PCC | rhombic PCC | calcined |
| | | | | clay |
| GE Brightness | 96.06 | 97.02 | 97.86 | 93.33 |
| L | 98.14 | 98.48 | 98.87 | 97.76 |
| a | 0.18 | 0.27 | 0.19 | −0.14 |
| b | 0.47 | 0.23 | 0.18 | 2.04 |
| BET sq m/g | 5.8 | 16.7 | 13.4 | 17.0 |
| % < 2 μm | 70.2 | 89.8 | 98.6 | 91.4 |
| d50 in μm | 1.43 | 0.43 | 0.36 | 0.61 |

Preparation of the inventive pigment Samples A-C and the kaolin clay sample above were slurried and dispersed with an anionic dispersant comprising a sodium salt of a maleic acrylic copolymer (sodium salt of an acrylic/maleic acid copolymer having a 2:1 molar acrylic/maleic acid ratio and average molecular mass of 4000) until a minimum viscosity was achieved. The carbonate was then slightly overdispersed with the anionic dispersant. The cationic polymer, epichlorohydrin/dimethylamine copolymer (bulk viscosity=40006000 cps), was added until a minimum viscosity was achieved.

Formulations comprising the samples were prepared, as shown in the table below.

| Component | Sample | Sample | Sample | Sample | Clay |
|---|---|---|---|---|---|
| (parts) | A1 | A2 | B | C | Sample |
| Dry Pigment | 100 | 100 | 100 | 100 | 100 |
| Airvol 502 | 8 | 6 | 16 | 12.5 | 16 |
| (Polyvinyl | | | | | |
| alcohol) | | | | | |
| Leucophor | 2.75 | 2.75 | 2.75 | 2.75 | 2.75 |
| FTS (optical | | | | | |
| brightening | | | | | |
| agent) | | | | | |

Printing results. The formulations were coated onto paper. The table below shows a comparison of the printing with uncoated HP Bright White Inkjet paper. The higher the wicking value, the better the performance.

| | | CIE | Black | Magenta | Cyan | Yellow | |
|---|---|---|---|---|---|---|---|
| Sam- | | White- | Print | Print | Print | Print | Wick- |
| ple | b* | ness | Density | Density | Density | Density | ing |
| A1 | −11.6 | 141.7 | 1.34 | 0.87 | 0.80 | 0.79 | 1.40 |
| A2 | −11.6 | 141.9 | 1.38 | 0.88 | 0.82 | 0.81 | 1.48 |
| B | −10.9 | 138.1 | 1.18 | 0.81 | 0.76 | 0.74 | 0.19 |
| C | −12.0 | 143.5 | 1.27 | 0.83 | 0.72 | 0.74 | 1.13 |
| Clay | −5.7 | 115.7 | 1.19 | 0.79 | 0.64 | 0.65 | 0.22 |
| Sam- | | | | | | | |
| ple | | | | | | | |
| HP | −13.5 | 149.6 | 1.20 | 0.74 | 0.74 | 0.68 | 0.43 |

It can be seen that the paper coated with the inventive Samples A1, A2, B, and C, which all contained carbonate pigments, achieved higher print densities and higher wicking performances, compared to the paper coated with the clay formulation and the uncoated paper.

### EXAMPLE 5

The performance of a paper coated with one of the inventive formulations, Sample A1, was compared against coatings made with: prior art pigments, FK-310 and Astrajet 3010; a commercially available paper (HP Premium Inkjet Paper); and a paper coated with the Clay Sample. The formulations and the printing results are tabulated below.

| Component | | | | |
|---|---|---|---|---|
| (parts) | Sample A1 | Clay Sample | Astrajet 3010 | FK-310 |
| Dry Pigment | 100 | 100 | 100 | 100 |
| Airvol 502 | 8 | 16 | 16 | 200 |
| (Polyvinyl | | | | |
| alcohol) | | | | |
| Leucophor | 2.75 | 2.75 | 2.75 | 2.75 |
| FTS (optical | | | | |
| brightening | | | | |
| agent) | | | | |

| | | CIE | Black | Magenta | Cyan | Yellow | |
|---|---|---|---|---|---|---|---|
| Sam- | | White- | Print | Print | Print | Print | Wick- |
| ple | b* | ness | Density | Density | Density | Density | ing |
| As- | −5.2 | 114.6 | 1.19 | 0.99 | 1.06 | 0.86 | 0.52 |
| tra- | | | | | | | |
| jet | | | | | | | |
| 3010 | | | | | | | |
| FK- | −8.8 | 130.5 | 1.39 | 1.20 | 1.38 | 0.99 | 3.07 |
| 310 | | | | | | | |
| Clay | −3.4 | 107.0 | 1.26 | 1.12 | 1.15 | 0.89 | 0.69 |
| Sam- | | | | | | | |
| ple | | | | | | | |
| Sam- | −7.4 | 124.8 | 1.43 | 1.10 | 1.14 | 0.92 | 0.65 |
| ple | | | | | | | |
| A1 | | | | | | | |
| HP | −11.9 | 138.0 | 1.57 | 1.29 | 1.44 | 1.00 | 2.85 |

The inventive Sample A1 displayed an improved whiteness as compared to the kaolin clay sample without a loss in printability. FK-310 is a commercial silica pigment that can be used in ink jet formulations. It has a very high surface area of about 600 m²/g. High surface areas are commonly cited as a key property for good ink jet printability. Despite the FK-310 having an advantageously high surface area, inventive Sample A1 achieved an unexpectedly similar performance.

### EXAMPLE 6

Effects of anionic dispersant. This Example illustrates how the anionic dispersant can affect the print quality. Properties of cationically dispersed ground calcium carbonate are tabulated below, comparing the polyacrylate dispersant to the maleic acrylic dispersant. Quantities added are as received and not corrected for solids.

| | | | Solids | | | |
|---|---|---|---|---|---|---|
| | Anionic | Amount | content | Brookfield | | |
| Anionic | Dispersant | of poly | of | Viscosity | Mutek | |
| Dis- | amount | EPI/DMA | slurry | (100 rpm, | charge | |
| persant | (lbs/ton) | (lbs/ton) | (%) | #4 spindle) | level | pH |
| maleic | 8 | 40 | 64.1 | 90 | 550 | 8.3 |
| acrylic* | | | | | | |
| poly- | 12 | 100 | 64 | 180 | 1100 | 7.9 |
| acrylate | | | | | | |

*sodium salt of an acrylic/maleic acid copolymer having a 2:1 molar acrylic/maleic acid ratio and average molecular mass of 4000

These values translate to 1.48 wt. % as received on the pigment for the polyacrylate dispersant and 1.11 wt % as received on pigment for the salt of the maleic acrylic dispersant. The pEPI/DMA levels were 5.0 wt % and 2.0 wt % as received on the pigment. It can be seen that a lower dosage of maleic acrylic copolymer is needed compared with the polyacrylate.

Various inventive coating formulations were prepared with ground calcium carbonate while varying the anionic dispersant used, and compared with the commercially available Astrajet 3010, as tabulated below.

| | | | | | Astra- |
|---|---|---|---|---|---|
| Component | | | | | jet |
| (parts) | Sample E | Sample F | Sample G | Sample H | 3010 |
| Anionic | poly- | maleic | poly- | maleic | |
| dispersant | acrylate | acrylic* | acrylate | acrylic* | |
| used | | | | | |
| Dry Pigment | 100 | 100 | 100 | 100 | 100 |
| Airvol 502 | 20 | 20 | 8 | 8 | 8 |
| (Polyvinyl | | | | | |
| alcohol) | | | | | |
| Leucophor | 2.75 | 2.75 | 2.75 | 2.75 | 2.75 |
| FTS (optical | | | | | |
| brightening | | | | | |
| agent) | | | | | |

*sodium salt of an acrylic/maleic acid copolymer having a 2:1 molar acrylic/maleic acid ratio and average molecular mass of 4000

The formulations were coated on paper and the results tabulated below.

| | | CIE | Black | Magenta | Cyan | Yellow | |
|---|---|---|---|---|---|---|---|
| Sam- | | White- | Print | Print | Print | Print | Wick- |
| ple | b* | ness | Density | Density | Density | Density | ing |
| Sam- | −8.9 | 131.3 | 1.45 | 1.28 | 1.34 | 0.95 | 1.2 |
| ple E | | | | | | | |
| Sam- | −8.3 | 129.0 | 1.46 | 1.21 | 1.34 | 0.92 | 2.1 |
| ple F | | | | | | | |
| Sam- | −8.1 | 127.6 | 1.55 | 1.04 | 1.21 | na | 2.1 |
| ple G | | | | | | | |
| Sam- | −7.8 | 126.4 | 1.52 | 1.03 | 1.22 | 0.81 | 2.2 |
| ple H | | | | | | | |
| As- | −4.2 | 110.9 | 1.37 | 1.01 | 1.27 | 0.80 | 4.7 |
| tra- | | | | | | | |
| jet | | | | | | | |
| 3010 | | | | | | | |
| HP | −11.9 | 138.0 | 1.54 | 1.39 | 1.50 | 0.96 | 1.9 |

These results show an improved wicking performance for the carbonate predispersed with the anionic maleic acrylic copolymer.

### EXAMPLE 7

This Example describes the benefits, e.g., good printing properties, of using a maleic acrylic polymer as the anionic dispersant. In this Example, calcium carbonate coatings are prepared where the type of anionic dispersant present in the coating composition is varied.

A slurry containing ground calcium carbonate (ISO brightness=95±1, BET surface area=12±3 m²/g, 95%±3<2 μm, d50˜0.6 μm) was prepared having a 72.5 wt % solids content. The ground calcium carbonate was overdispersed with either maleic acrylic polymer (MA 140) or sodium polyacrylate via the titration method described herein. Coating formulations were prepared by adding 1 pph epichlorohydrin/dimethylamine condensation polymer (MW=1,150,000) at 10 wt % solids, 8 pph Airvol 502 PVOH dissolved in hot water at 18.8 wt % solids, and NaOH solution at 4 wt % solids to adjust the pH from 6.8 to 8.5. The printing results are tabulated below. Over-dosing is determined with respect to the optimal dose for minimum rheology,

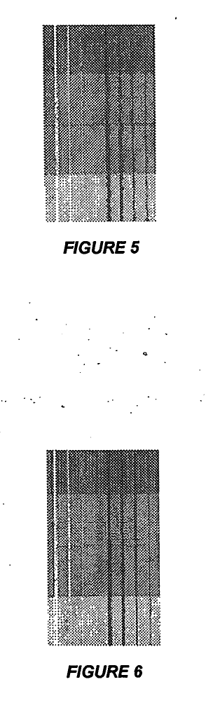

Hand drawdown coatings were made on base papers using various draw down rods. The coated papers were soft compact calendered for 1 nip at 50 kN and 50° C. The calendered coated papers were printed using the Epson Stylus Photo 870 inkjet printer with Epson Photo Quality Inkjet Paper settings. Two reference papers are included; Epson Premium paper (uncoated) and Epson Photo Coated (silica coating). The results are tabulated below.

| | Visual | | | | |
|---|---|---|---|---|---|
| | assessment | Epson Print Density | | | |
| | Of print | Photo Quality Setting | | | |
| Paper | quality | Black | Cyan | Mag | Yellow |
| Epson Premium | Good | 1.26 | 1.09 | 0.93 | 0.64 |
| Plain | | | | | |
| Epson Photo | Excellent | 1.87 | 1.80 | 1.53 | 0.97 |
| Coated | | | | | |
| GCC with | Some | 1.36 | 1.27 | 1.05 | 0.81 |
| sodium | wicking and | | | | |
| polyacrylate | bleeding | | | | |
| dispersant | See FIG. 5 | | | | |
| GCC with | Good | 1.5 | 1.22 | 1.23 | 0.90 |
| maleic | See FIG. 6 | | | | |
| acrylic | | | | | |
| dispersant | | | | | |

FIG. 5 is a photograph of a printed test pattern resulting from ink jet printing onto a coated paper comprising GCC with sodium polyacrylate dispersant. FIG. 6.is a photograph of a printed test pattern resulting from ink jet printing onto a coated paper comprising GCC with maleic acrylic dispersant. It can be seen that the resolution of the lines and their print densities in FIG. 6 is superior to that of FIG. 5.

### EXAMPLE 8

This Example describes a paper coated a formulation comprising precipitated calcium carbonate (PCC) (rhombic PCC, GE Brightness=97.9, BET surface area=13.4 m²/g, 98.6%<2 μm, d50=0.36 μm). The PCC was dispersed via the titration technique described in Example 1. A precipitated calcium carbonate slurry was prepared by adding 427 g of filter cake (93.7% solids) to 135 grams of water and 10.21 g maleic acrylic polymer dispersant (MA 140). An additional 1.33 g of the dispersant was added in order to obtain a Brookfield reading for a total of 11.54 g dispersant (71.2 solids wt %). Maleic acrylic polymer dispersant was titrated to the PCC slurry in 0.2 gram increments. The resulting Brookfield viscosity values are tabulated below.

| Amount dispersant added (g) | Brookfield Viscosity mPa · s |
|---|---|
| 11.54 (initial) | 800 |
| 0.2 | 420 |
| 0.2 | 200 |
| 0.2 | 180 |
| 0.2 | 170* |
| 0.2 | 180 |

*optimum

The PCC was overdispersed by 0.2 g, resulting in the addition of 12.54 g total of dispersant (3.14% or 62.7 lbs/ton).

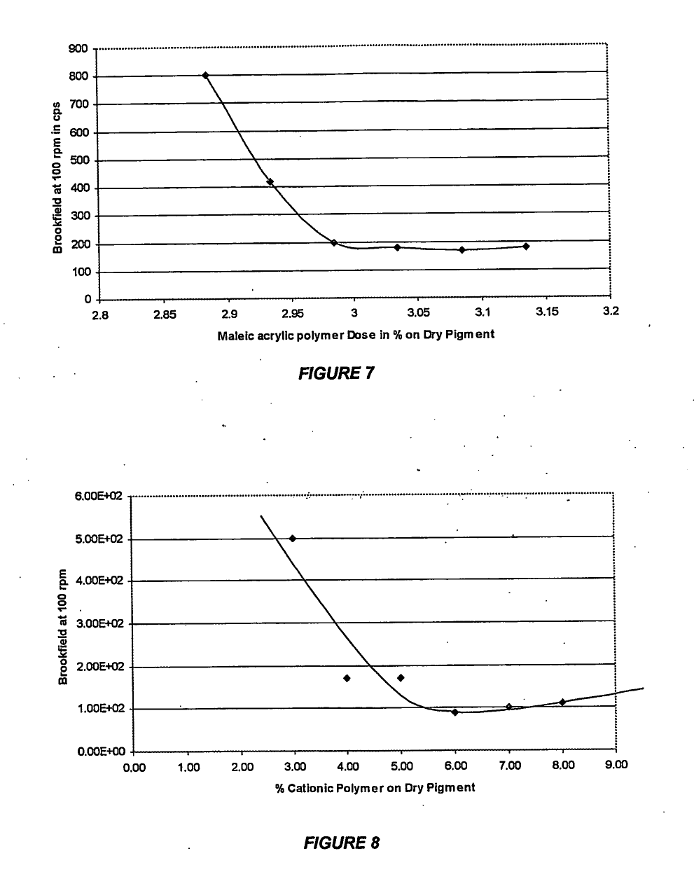

FIG. 7 shows the titration plot of raleic acrylic polymer dispersant dosage (x-axis) versus Brookfield viscosity (y-axis) of the slurry. The Brookfield viscosity is measured by using a Brookfield Viscometer with a #2 spindle set at a spindle speed of 20 rpm.

The cationic polymer, an epichlorohydrin/dimethylamine condensation polymer(bulk viscosity=2040-2840 cps), was titrated in 20 lbs/ton increments to the dispersed PCC in a manner similar to that described in Example 2.

| Total amount cationic polymer added | Brookfield Viscosity |
|---|---|
| (pound/ton) | (mPa · s) |
| 20 | no reading too thick |
| 40 | no reading too thick diluted |
| 60 | 500, still too thick |
| 80 | 170 (#4 spindle @100 rpm) |
| 100 | 170 (#4 spindle @100 rpm) |
| 120 | 90 (#4 spindle @100 rpm)* |
| 140 | 100 (#4 spindle @100 rpm) |
| 160 | 110 (#4 spindle @100 rpm) |

*optimum

It was determined that the optimal amount of cationic polymer, was 130 lbs./ton. FIG. 8 is a titration plot of dose of cationic polymer (pEPI/DMA) combined with the dispersed PCC (x-axis) versus Brookfield viscosity (y-axis).

What is claimed is:

1. A pigment composition, comprising:
at least one calcium carbonate chosen from rhombohedral calcium carbonate and ground calcium carbonate;
at least one anionic dispersant present in an amount sufficient to overdisperse the at least one calcium carbonate; and
at least one cationic polymer.

2. The pigment composition according to claim 1, wherein the at least one calcium carbonate comprises ground calcium carbonate.

3. The pigment composition according to claim 2, wherein the ground calcium carbonate has a median particle size of about 1.2 μm or less.

4. The pigment composition according to claim 1, wherein the at least one anionic dispersant is chosen from a maleic anhydride copolymer, and a polyacrylate.

5. The pigment composition according to claim 4, wherein the at least one anionic dispersant is a maleic acrylic copolymer.

6. The pigment composition according to claim 1, wherein the at least one cationic polymer is chosen from polydiallyidimethylammonium chloride, copolymers of quaternary dimethylaminoethyl acrylate, and copolymers of quaternary dimethylaminoethyl methacrylate.

7. The pigment composition according to claim 1, wherein the at least one cationic polymer comprises a copolymer of epichlorohydrin and dimethylamine.

8. The pigment composition according to claim 1, wherein the at least one cationic polymer has a bulk viscosity of at least about 300 cps.

9. The pigment composition according to claim 1, wherein the at least one cationic polymer has a bulk viscosity of at least about 2,000 cps.

10. The pigment composition according to claim 1, wherein the at least one calcium carbonate has a surface area ranging from about 5 m²/g to about 600 m²/g.

11. The pigment composition according to claim 1, wherein the at least one calcium carbonate has a surface area ranging from about 5 m²/g to about 20 m²/g.

12. The pigment composition according to claim 1, wherein the at least one anionic dispersant comprises a maleic acrylic copolymer and the at least one cationic polymer is polydiallyidimethylammonium chloride.

13. The pigment composition according to claim 1, wherein the at least one anionic dispersant is a maleic acrylic copolymer and the at least one cationic polymer comprises a copolymer of epichlorohydrin and dimethylamine.

14. The pigment composition according to claim 1, wherein the at least one calcium carbonate comprises rhombohedral calcium carbonate.

15. The pigment composition according to claim 14, wherein the rhombohedral calcium carbonate has a median particle size of about 0.5 or less.

16. A method of preparing a pigment, comprising:
combining at least one anionic dispersant with at least one calcium carbonate chosen from rhombohedral calcium carbonate and ground calcium carbonate, the at least one anionic dispersant being present in an amount effective to overdisperse the at least one calcium carbonate; and
combining at least one cationic polymer with the dispersed calcium carbonate.

17. The method according to claim 16, wherein the at least one calcium carbonate comprises rhombohedral calcium carbonate having a median particle size of about 0.5 μm or less.

18. The method according to claim 17, wherein the at least one rhombohedral calcium carbonate has a median particle size of about 0.4 μm or less.

19. The method according to claim 16, wherein the dispersed carbonate is combined with the at least one cationic polymer, the at least one cationic, polymer being present in an amount of at least about 2 weight percent, relative to the weight of the at least one calcium carbonate.

20. The method according to claim 16, wherein the dispersed carbonate is combined with the at least one cationic polymer, the at least one cationic polymer being present in an amount of at least about 3 weight percent, relative to the weight of the at least one calcium carbonate.

21. The method according to claim 16, wherein the additional amount to achieve over dispersion of the at least one anionic dispersant ranges from about 0.25 times to about 10 times the amount sufficient to achieve a minimum viscosity.

22. The method according to claim 16, wherein the amount of the at least one anionic dispersant added ranges from about 0.1% to about 5% by weight relative to the weight of the at least one calcium carbonate.

23. The method according to claim 16, wherein the amount of the at least one anionic dispersant added ranges from about 0.5% to about 5% by weight relative to the weight of the atleast one calcium carbonate.

24. The method according to claim 16, wherein the amount of the at least one anionic dispersant added ranges from about 1% to about 5%,by weight relative to the weight of the calcium carbonate.

25. The method according to claim 16, wherein the at least one cationic polymer has a bulk viscosity of at least about 300 cps.

26. The method according to claim 16, wherein the at least one calcium carbonate has a surface area ranging from about 5 m²/g to about 600 m²/g.

27. The method according to claim 16, wherein the at least one calcium carbonate has a surface area ranging from about 5 m²/g to about 20 m²/g.

28. The method according to claim 16, wherein the at least one anionic dispersant is chosen from a maleic acrylic copolymer, a maleic anhydride copolymer, and a polyacrylate.

29. The method according to claim 16, wherein the at least one cationic polymer comprises a cationic quaternary ammonium polymer.

30. The method according to claim 16, wherein the at least one cationic polymer is chosen from a copolymer of epichlorohydrin/dimethylamine, polydiallyldimethylammonium chloride, copolymers of quaternary dimethylaminoethyl acrylate, and copolymers of quaternary dimethylaminoethyl methacrylate.

31. The method according to claim 16, wherein said pigment has a solids concentration ranging from about 50% to about 65% solids.

32. The method according to claim 16, wherein said pigment has a solids concentration ranging from about 55% to about 60% solids.

33. A paper coating composition, comprising:
at least one calcium carbonate chosen from rhombohedral calcium carbonate and ground calcium carbonate;
at least one anionic dispersant present in an amount effective to overdisperse the at least one calcium carbonate;
at least one cationic polymer; and
at least one binder.

34. The paper coating composition according to claim 33, wherein the at least one calcium carbonate comprises rhombohedral calcium carbonate having a median particle size of about 0.5 μm or less.

35. The paper coating composition according to claim 33, wherein the at least one anionic dispersant is chosen from a maleic acrylic copolymer, a maleic anhydride copolymer, and a polyacrylate.

36. The paper coating composition according to claim 33, wherein the at least one cationic polymer comprises a cationic quaternary ammonium polymer.

37. The paper coating composition according to claim 33, wherein the at least one cationic polymer is chosen from copolymers of epichlorohydrin/dimethylamine, polydiallyldimethylammonium chloride, copolymers of quaternary dimethylaminoethyl acrylate, and copolymers of quaternary dimethylaminoethyl methacrylate.

38. The paper coating composition according to claim 33, wherein the at least one anionic dispersant is chosen from a maleic acrylic copolymer, a maleic anhydride copolymer, and a polyacrylate; and the cationic polymer is chosen from cationic quaternary ammonium polymers.

39. The paper coating composition according to claim 33, wherein the at least one calcium carbonate is present in the composition in an amount ranging from about 20% to about 70% by weight relative to the total weight of the composition.

40. The paper coating composition according to claim 33, wherein ink printed on a coated paper comprising the paper coating composition has a cyan print density of at least about 0.75.

41. The paper coating composition according to claim 33, wherein ink printed on a coated paper comprising the paper coating composition has a magenta print density of at least about 0.5.

42. The paper coating composition according to claim 33, wherein ink printed on a coated paper comprising the paper coating composition has a wicking value of at least about 0.5.

43. The paper coating composition according to claim 33, wherein ink printed on a coated paper comprising the paper coating composition has a wicking value of at least about 1.

44. A coated paper, comprising:
a fibrous substrate:
at least one calcium carbonate chosen-from rhombohedral calcium carbonate and ground calcium carbonate;
at least one anionic dispersant present in an amount effective to overdisperse the at least one calcium carbonate;
at least one cationic polymer in an amount of at least about 2 weight percent, relative to the weight of the calcium carbonate; and
at least one binder.

45. The coated paper according to claim 44, wherein the at least one calcium carbonate comprises rhombohedral calcium carbonate having a median particle size of about 0.5 μm or less.

46. The coated paper according to claim 44, wherein ink printed on the coated paper has a cyan print density of at least about 0.75.

47. The coated paper according to claim 44, wherein ink printed on the coated paper has a magenta print density of at least about 0.5.

48. The coated paper according to claim 44, wherein ink printed on the coated paper has a wicking value of at least about 0.5.

49. The coated paper according to claim 44, wherein ink printed on the coated paper has a wicking value of at least about 1.

50. A method of preparing a pigment, comprising:
(a) adding substantially simultaneously to a vessel, at least one anionically dispersed carbonate slurry and at least one cationic polymer, to form a cationic carbonate slurry; and
(b) removing the cationic carbonate slurry from the vessel at a rate equal to the sum of the rate of the cationic polymer and dispersed carbonate slurry addition in (a).

51. The method according to claim 50, wherein the adding in (a) occurs at a rate ranging from about 1% to about 25% of the vessel slurry volume per minute.

52. The method according to claim 50, wherein the removing in (b) occurs at a rate ranging from about 2% to about 12% of the vessel slurry volume per minute.

53. The method according to claim 52, wherein the removing in (b) occurs at a rate ranging from about 3% to about 10% of the vessel slurry volume per minute.

54. The method according to claim 50, wherein the carbonate is calcium carbonate.

55. The method according to claim 54, wherein the calcium carbonate is chosen from rhombohedral calcium carbonate and ground calcium carbonate.

56. The method according to claim 55, wherein the carbonate comprises rhombohedral calcium carbonate having a median particle size of about 0.5 μm or less.

57. A pigment composition, comprising:
at least one rhombohedral calcium carbonate;
at least one anionic dispersant; and
at least one cationic polymer.

58. The pigment composition according to claim 57, wherein the at least one rhombohedral calcium carbonate has a median particle size of about 0.5 μm or less.

59. The pigment composition according to claim 57, wherein the at least one rhombohedral calcium carbonate has a median particle size of about 0.4 μm or less.

60. The pigment composition according to claim 57, wherein the at least one rhombohedral calcium carbonate has a median particle size of about 0.3 μm or less.

61. The pigment composition according to claim 57, wherein the at least one cationic polymer is present in the composition in an amount of at least about 2 percent by weight, relative to the weight of calcium carbonate.

62. The pigment composition according to claim 61, wherein the at least one cationic polymer is present in the composition in an amount of at least about 3 percent by weight, relative to the weight of calcium carbonate.

63. The pigment composition according to claim 57, wherein the at least one anionic dispersant is present in the composition in an amount ranging from about 0.1% to about 5% by weight, relative to the weight of calcium carbonate.

64. The pigment composition according to claim 57, wherein the at least one anionic dispersant is present in the composition in an amount of at least about 0.5% by weight, relative to the weight of calcium carbonate.

65. The pigment composition according to claim 57, wherein the at least one anionic dispersant is present in the composition in an amount of at least about 1% by weight, relative to the weight of calcium carbonate.

66. The pigment composition according to claim 57, wherein the at least one anionic dispersant is chosen from a maleic acrylic copolymer, a maleic anhydride copolymer, and a polyacrylate.

67. The pigment composition according to claim 57, wherein the at least one cationic polymer comprises a cationic quaternary ammonium polymer.

68. The pigment composition according to claim 57, wherein the at least one cationic polymer is chosen from copolymers of epichlorohydrin/dimethylamine, polydiallyldimethylammonium chloride, copolymers of quaternary dimethylaminoethyl acrylate, and copolymers of quaternary dimethylaminoethyl methacrylate.

69. The pigment composition according to claim 57, wherein the at least one anionic dispersant is chosen from a maleic acrylic copolymer, a maleic anhydride copolymer, and a polyacrylate; and the cationic polymer is chosen from cationic quaternary ammonium polymers.

70. The pigment composition according to claim 57, wherein said pigment composition has a solids concentration ranging from about 40% to about 65% solids.

71. The pigment composition according to claim 57, wherein said pigment composition has a solids concentration ranging from about 50% to about 65% solids.

72. The pigment composition according to claim 57, wherein said pigment composition has a solids concentration ranging from about 55% to about 60% solids.

73. The pigment composition according to claim 57, wherein the at least one rhombohedral calcium carbonate has a surface area ranging from about 5 m²/g to about 600 m²/g.

74. The pigment composition according to claim 57, wherein the at least one rhombohedral calcium carbonate has a surface area ranging from about 5 m²/g to about 20 m²/g.
